(19) United States
(12) Patent Application Publication
(10) Pub. No.: US 2026/0077283 A1
(43) Pub. Date: Mar. 19, 2026

(54) MODULAR FILTER CORE

(71) Applicant: Sonoco Development, Inc., Hartsville, SC (US)

(72) Inventors: Chad Lagace, Cohoes, NY (US); Richard Sayers, Valatie, NY (US)

(21) Appl. No.: 18/890,222

(22) Filed: Sep. 19, 2024

(51) Int. Cl. B01D 35/30

(52) U.S. Cl. CPC B01D 35/303; B01D 2201/0415; B01D 2201/4084

(57) ABSTRACT

A filter core segment for use in forming a filter core is provided herein. The filter core segment comprises a male end comprising a male rib defining an outer surface and an opposite inner surface. The male end further comprises an inner support disposed radially inward from an inner surface of the male rib. The male end further comprises a first and second extension each comprising a neck extending from the inner surface of the male rib and a head attached thereto. The filter core segment further comprises a neutral end opposite the male end, and a plurality of columns extending therebetween. The filter core segment further comprises a plurality of ribs extending about the plurality of columns. The first and second extension are configured to engage a male end or a neutral end of an adjacent filter core segment to form the filter core.

### FIELD

Embodiments herein relate generally to filter cores, and more particularly, to filter cores segments having variable lengths which are connected utilizing physical connections to create a filter core.

### BACKGROUND

Filter cores are utilized to provide structural support to filter media to prevent filter media from collapsing or deforming under pressure, fluid flow, or other circulation. Many filter cores come in defined lengths, which may then be (a) cut when the filter core is larger than needed, or (b) welded, or otherwise secured to a second filter core, when the filter core is smaller than needed. Changing the length of the filter core provides challenges including rough edges and imprecise core lengths, among others.

Modular filter cores may be used to form filter cores of discrete lengths; however, the known modular filter cores utilize male and female components, limiting the manner of attachment of one element to another and resulting in a finished core that may have exposed edges, such that the edge surfaces are not uniform (e.g., level). To explain, the filter cores may include a male end which includes at least one male element which extends away from the edge surface, and a female end which defines an internal feature to receive the male element extending from the male end. Thus, the male end feature may include a protruding pin, thread, or similar, and the female end may have corresponding holes, threads, or recesses to accept the male end. In this regard, the male end is configured to only engage with a female end, and the female edge is configured to only engage with a male end. Thus, when the modular filter core is assembled there is an exposed male end, and an exposed female end.

When the male end is exposed, the male element may break, and when the female end is exposed, the internal feature may fill with an unwanted medium. Alternatively, to reduce the exposure of the male end and the female end, one or more end caps may be positioned on each of the male end and/or the female end to create a uniform surface on the edge, however, the end caps are specifically designed, for example a first end cap for the male end and a second end cap for the female end, thereby requiring additional distinct elements. Further, the end cap(s) add additional length into the filter core and may require additional space to account for the end cap or may require the modular filter cores to be cut down and welded to create the desired length for the filter core.

Through ingenuity and hard work, the inventors have developed an improved modular filter core which may be assembled and connected, and disassembled and disconnected, to form filter cores of varying lengths.

### BRIEF SUMMARY

Embodiments of the present disclosure are directed towards apparatus and methods of forming variable length filter cores. The filter cores are modularly formed with a male end and a neutral end wherein the male end may engage either the neutral end or another male end to provide a filter core of the desired size wherein the filter core does not require additional components (e.g., end caps) to form a uniform external surface. Thus, the duality of the male end, being able to connect to both an adjacent male end or an adjacent neutral end, allows more options for filter core sizing and allows the filter core to have a uniform shape on the neutral end of the filter core.

Embodiments of the present disclosure are directed towards a filter core comprised of adjacent filter core segments. Each filter core segment comprises a male end and a neutral end, with a plurality of columns extending therebetween. The filter core segments further include a plurality of ribs circumscribing the plurality columns. The length of the filter core segment is correlated to the number of ribs therein. Additionally, the male end of the filter core segment and the neutral end of the filter core segment may be configured as ribs, such that the filter core segment defines a uniform pattern. The male end of the filter core segment comprises at least one extension extending away from the male end. The at least one filter extension is configured to engage an adjacent filter core segment at either the male end or the neutral end.

In an example embodiment a filter core segment is provided. The filter core segment comprises a male end and a neutral end disposed opposite the male end. The male end comprises a male rib defining an outer surface and an inner surface, circumscribing a perimeter of the male end. The male end further comprises an inner support disposed radially inward from the inner surface. A first extension and a second extension extend from the male rib and each comprise a neck and a head. The neck extends from the inner surface of the male rib, and the head extends from the neck, and protrudes radially outwards from the inner surface of the male rib towards a plane of the outer surface of the male rib. The filter core segment further comprises a plurality of columns extending between the male end and the neutral end, and a plurality of ribs extending about the plurality of columns. The first extension and the second extension are configured to engage either the male end or the neutral end of an adjacent filter core segment.

In some embodiments, the neutral end circumscribes a perimeter of the neutral rib, the neutral rib being a uniform body which does not have any openings to receive the male end. In some embodiments, the first extension and the second extension may be diametrically opposed. In some embodiments, the plurality of columns may be evenly spaced about the perimeter of the male rib. In some embodiments, the plurality of ribs may be evenly spaced between the male end and the neutral end.

In some embodiments, the male end may further comprise a plurality of braces extending between the external edge and the inner support. In some embodiments, the plurality of columns may be aligned with the plurality of braces.

In some embodiments, the male rib and the neutral rib may each have the same height. In some embodiments, the height of the neck of the first extension may be the same as a height of the neck of the second extension, the height of the male rib, and the height of the neutral rib.

In some embodiments, the neck defines a neck thickness, which may be consistent along the neck. In some embodiments, the head may define a variable head thickness which is at a maximum at the transition between the neck and the head.

In another example embodiment a filter core is provided. The filter core comprises a first filter core segment and a second filter core segment. Each of the first filter core segment and the second filter core segment comprise a male end and a neutral end disposed opposite the male end. The male end comprises a male rib defining an outer surface and an inner surface, circumscribing a perimeter of the male end. The male end further comprises an inner support disposed radially inward from the inner surface. A first extension and a second extension extend from the male rib and each comprise a neck and a head. The neck extends from the inner surface of the male rib, and the head extends from the neck, and protrudes radially outwards from the inner surface of the male rib towards a plane of the outer surface of the male rib. The filter core segment further comprises a plurality of columns extending between the male end and the neutral end, and a plurality of ribs extending about the plurality of columns. The male end of the first filter core segment is engaged with one of either the male end or the neutral end of the second filter core segment.

In some embodiments, the neutral end circumscribes a perimeter of a neutral rib which is a uniform body which does not have any openings to receive the male end. In some embodiments, the first extension and the second extension may be diametrically opposed. In some embodiments, the plurality of columns may be evenly spaced about the perimeter of the male rib. In some embodiments, the plurality of ribs may be evenly spaced between the male end and the neutral end.

In some embodiments, the male end may further comprise a plurality of braces extending between inner surface of the male rib and the inner support. In some embodiments, the plurality of columns are aligned with the plurality of braces.

In some embodiments, a height of the neck of the first extension may be the same as a height of the neck of the second extension, a height of the male rib and a height of a neutral rib. In some embodiments, the neck defines a neck thickness which is consistent along the neck. In some embodiments, the head defines a variable head thickness which is at a maximum at the transition between the neck and the head.

In some embodiments, the filter core segment further comprises a third filter core segment comprising a male end and a neutral end opposite the male end. The male end comprises a male rib defining an outer surface and an inner surface, circumscribing a perimeter of the male end. The male end further comprises an inner support disposed radially inward from the inner surface. A first extension and a second extension extend from the male rib and each comprise a neck and a head. The neck extends from the inner surface of the male rib, and the head extends from the neck, and protrudes radially outwards from the inner surface of the male rib towards a plane of the outer surface of the male rib. The filter core segment further comprises a plurality of columns extending between the male end and the neutral end, and a plurality of ribs extending about the plurality of columns. The first and second extension of the third filter core segment may engage with the neutral end of the first filter core segment, the male end of the second filter core segment, or the neutral end of the second filter core segment.

In yet another example embodiment a filter core segment is provided. The filter core segment comprises a male end comprising a male rib defining an outer surface and an opposite inner surface which circumscribes a perimeter of the male end. The male end further comprises an inner support attached to the plurality of braces. The male end further comprises at least one extension extending away from the male rib. The at least one extension comprises a neck extending from the inner surface of the male rib, and a head extending from the neck. The filter core segment further comprises a neutral end comprising a neutral rib circumscribing a perimeter of the neutral end. The filter core segment further comprises a plurality of columns extending between the male rib and the neutral rib, and a plurality of ribs concentrically spaced about the plurality of columns between the male rib and the neutral rib. The filter core segment further comprises a plurality of windows formed between the plurality of columns and the plurality of ribs. A window adjacent the male rib or the neutral rib is configured to receive the head of at least one extension of an adjacent filter core segment.

### BRIEF DESCRIPTION OF THE SEVERAL VIEWS OF THE DRAWING(S)

Reference will now be made to the accompanying drawings, which are not drawn to scale, and wherein:

FIG. 1 shows a perspective view of a filter core assembly comprising multiple filter core segments, in accordance with some embodiments discussed herein;

FIG. 2 shows a perspective view of an example filter core segment, in accordance with some embodiments discussed herein;

FIG. 3A illustrates a perspective view of a male end of the filter core segment, in accordance with some embodiments discussed herein;

FIG. 3B illustrates an extension of the filter core segments, in accordance with some embodiments discussed herein;

FIG. 4A illustrates two filter core segments secured together, in accordance with some embodiments discussed herein;

FIG. 4B illustrates a cross-sectional view of the male-neutral interface of the two filter core segments shown in FIG. 4A taken along line B-B, in accordance with some embodiments discussed herein;

FIG. 5A illustrates a perspective view of two filter core segments secured together, in accordance with some embodiments discussed herein; and

FIG. 5B illustrates a cross-sectional view of the male-male interface of the two filter core segments shown in FIG. 5A taken along line 1-1, in accordance with some embodiments discussed herein.

### DETAILED DESCRIPTION

Some example embodiments will not be described more fully herein with reference to the accompanying drawings, in which some, but not all example embodiments are shown.

Indeed, the examples described and pictured herein should not be construed as being limiting to the scope, applicability or configuration of the present disclosure. Rather, these example embodiments are provided so that this disclosure will satisfy applicable legal requirements. Like reference numerals refer to like elements throughout.

Directional terms as used herein—for example, up, down, left, right, front, back, top, bottom, vertical, and horizontal—are made only with reference to the figures as drawn and are not intended to imply absolute orientation.

Filter cores are used in various industries to provide support for filter media, which provides filtering properties. However, many filter cores require multiple segments to meet the necessary length. To meet the requisite length, the segments may be bonded together using solvents or other adhesives and/or may be cut to achieve the necessary length. In the present invention however, the filter core has an adjustable length without use of solvents, adhesives, or cutting of the core segments.

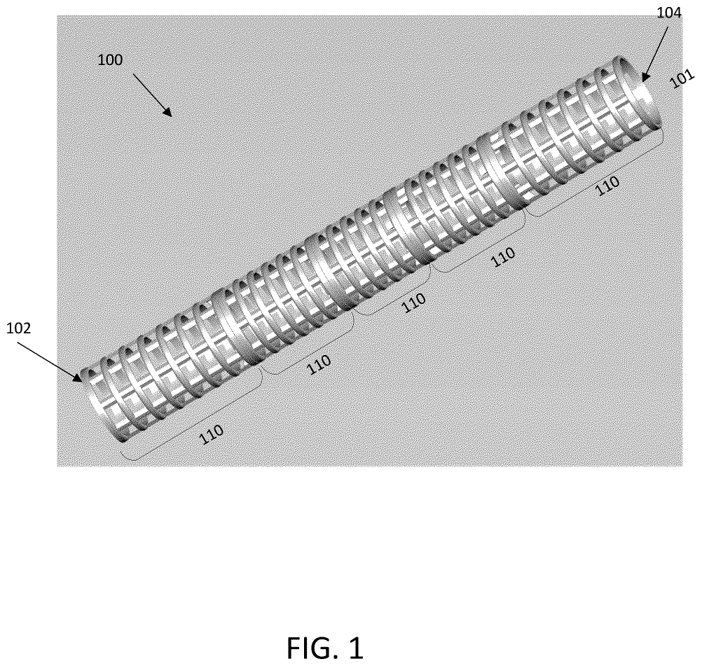

FIG. 1 illustrates a filter core 100 of the invention. The filter core 100 defines a first end 102 and an opposite second end 104. The filter core 100 may comprise a number of filter core segments 110 connected to one another. In this regard, the filter core 100 may comprise at least two filter core segments 110, at least three filter core segments, or at least four filter core segments. The filter core segments 110 may be mechanically connected to adjacent filter core segments 110, such as through a latching or locking mechanism, to create the filter core 100.

The filter core segments 110 may define multiple sizes such that the filter core segments, may be attached to create the filter core 100 at a desired length. In some embodiments, the filter core segments 110 may define a length between 1-5 in, between 1-7 in, or between 1-10 in. In some embodiments, the filter core segment 110 may be available in increments of 2 inches, 1 inch, or even half inch increments. In this regard, any length of core 100 may be created with the correct combination of filter core segments 110.

In an embodiment, the filter core segments may be formed from a molded thermoplastic material, for example, acrylonitrile butadiene styrene (ABS), polypropylene, polyethylene, polyethylene terephthalate, or any other material known in the art. In some embodiments, the filter core segments 110 may be formed of glass or glass filled ABS.

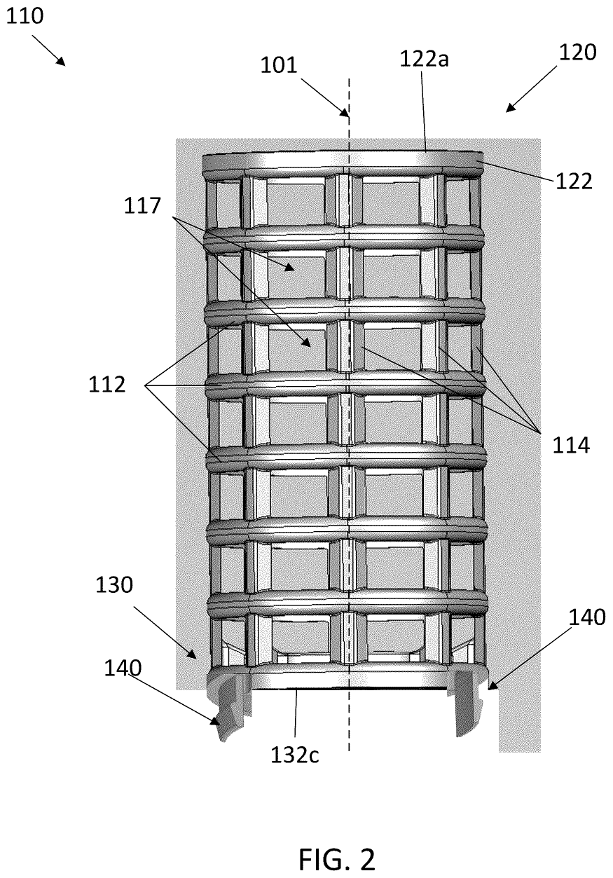

FIG. 2 illustrates an example filter core segment 110 in greater detail. The filter core segment 110 generally has an open, hollow cylindrical shape and comprises a plurality of columns 114 and a plurality of ribs 112 extending between a neutral end 120 and a male end 130. In some embodiments, the plurality of columns 114 may extend parallel to a central axis 101 of the cylindrical shape, which extends between the neutral end 120 and the male end 130.

The filter core segment 110 may define a perimeter circumscribed by the plurality of columns 114. In this regard, the arrangement of the plurality of columns 114 defines an exterior footprint of the filter core segment 110.

In some embodiments, the filter core segment 110 may comprise any number of columns 114, for example, three columns, four columns, five columns, or six columns. In some embodiments, the filter core segment 110 may comprise at least three columns, at least five columns, or at least seven columns. In some embodiments, the size of the filter core segment may correspond to the number of columns. For example, a filter core segment with a larger diameter may have a greater number of columns. While in other embodiments, the diameter of the filter core segment 110 has no effect on the number of columns. As will be described further herein, the columns may be spaced so as to receive an extension 140 and prevent rotation of adjacent filter core segments 110 relative to one another about the central axis 101.

The plurality of ribs 112 may extend about the plurality of columns 114. In this regard, each rib, of the plurality of ribs 112 may engage with each column of the plurality of columns 114. Said differently, the plurality of ribs 112 may circumscribe the plurality of columns 114, or otherwise extend about the external footprint of the plurality of columns 114. In some embodiments, the plurality of ribs 112 may be perpendicular to the central axis 101 and may extend in parallel planes relative to one another. In some embodiments, the plurality of ribs 112 are formed perpendicular to the plurality of columns 114, while in other embodiments, the plurality of ribs 112 may be angled in relation to the plurality of columns 114. In some embodiments, the plurality of ribs 112 may be evenly spaced between the neutral end 120 and the male end 130, while in other embodiments the plurality of ribs 112 may not be evenly spaced.

The number of ribs 112 positioned between the neutral end 120 and the male end 130 may correspond to the length of the filter core segment 110. In this regard, a greater number of ribs 112 translates to a greater length, and a smaller number of ribs 112 translates to a shorter length. For example, a filter core segment with five (5) ribs, may be shorter than a filter core segment with eight (8) ribs. In this regard, each filter core segment 110 forming the filter core 100 is similar in structure while varying in length.

In an embodiment, the ribs 112 may each have a curved, rectangular, triangular, or other shape or exterior profile. In an embodiment, the columns 114 may each have a curved, rectangular, triangular, or other shape or exterior profile. The intersections between the plurality of columns 114 and the plurality of ribs 112 define a plurality of windows 117 there between. The plurality of windows 117 may allow for a medium (e.g., water) to pass through the filter core segment 110.

In some embodiments, the neutral end 120 may define a neutral end rib 122 which comprises a terminal end of the plurality of columns 114. In this regard, the neutral end rib 122 may be configured as one of the plurality of ribs 112 or similar to one of the plurality of ribs 112. Notably, in contrast to a female end of modular filters, or devices, which comprises an internal feature, (e.g., holes, threads, and/or recesses) to receive a protruding feature of the male end (e.g., protruding pins, threads, etc.). the neutral end 120 may not have either internal features, or protruding features to engage with the male end 130.

Similarly, the male end 130 may define a male rib 131 which comprises a terminal end of the plurality of columns 114. In this regard, the male rib 131 may be configured as one of the plurality of ribs, or similar to the plurality of ribs 112.

In some embodiments, the neutral end rib 122 may comprise a base wall 122a on a terminal, longitudinal end of the neutral end 120, and the male rib 131 may comprise a base wall 132c on a terminal, longitudinal end of the male end 130. Notably the neutral base wall 122a may be shaped complimentary to the male base wall 132c. To explain, the neutral base wall 122a may be flat rather than curved like the plurality of ribs 112, and the male base wall 132c may also be flat so as to compliment the neutral base 122a when they are disposed adjacent one another. In another embodiment, the male base wall 132c may comprise an indent, and the neutral base wall 122a may comprise a protrusion which is engageable with the male base wall 132c. In this way, the male base wall 132c and the neutral base wall 122a may be locked into place together.

The male end 130 may further comprise at least one extension 140. The at least one extension 140 may extend away from the male end 130, parallel to the central axis 101. In some embodiments, the at least one extension 140 may comprise two extensions diametrically opposed from one another. While in other embodiments, the at least one extension may comprise multiple extensions evenly spaced about the male end 130. In some embodiments, the number of extensions 140 may be less than the number of columns 114. In some embodiments, the number of extensions 140 may be at least half the number of columns 114, while in other embodiments the number of extensions 140 may be at least a third of number of columns 114. For example, the illustrated embodiment comprises two extensions 140 and six columns 114.

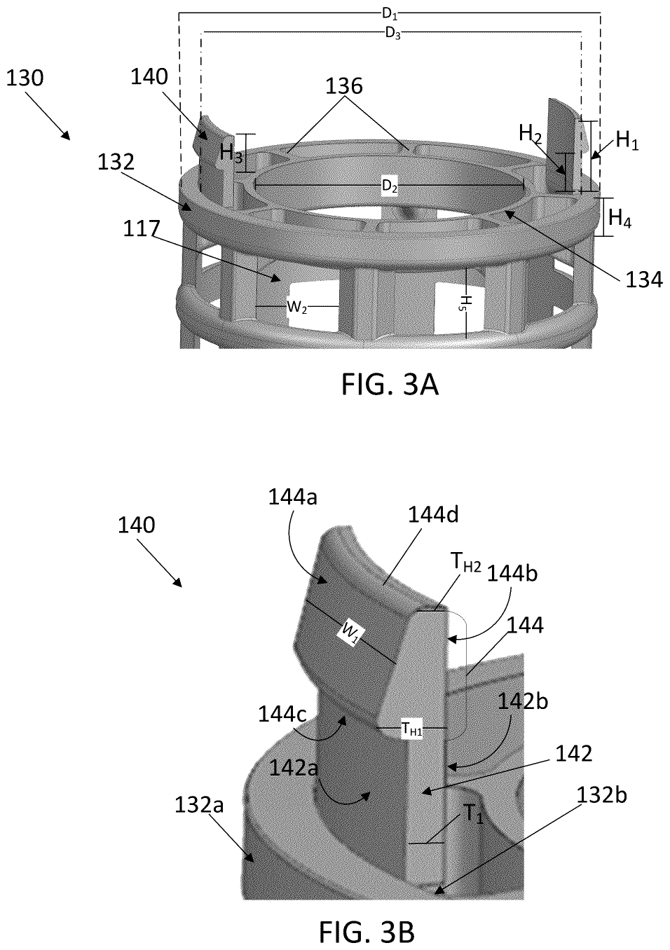

FIGS. 3A-B illustrate the male end 130 in greater detail. In some embodiments, the male end 130, specifically the male rib 132 defines an external surface 132a and an opposite surface 132b. The external surface 132a may circumscribe the outer diameter of the male end 130 and the inner surface 132b may circumscribe the inner diameter of the terminal rib of the male end 130 (e.g., the male rib 132). In some embodiments, filter core segment 110 may define an outer diameter D₁ (see FIG. 3A), which is measured from the external surface 132a on one side of the filter core segment 110 to the external surface 132a on the other side of the filter core segment 110. In some embodiments, filter core segment 110 may define an inner diameter D₃ (see FIG. 3A), which is measured from the inner surface 132b on one side of the filter core segment 110 to the inner surface 132b on the other side of the filter core segment 110.

In order to provide the requisite support to the filter core 100, when formed of adjacent filter core segments 110, the male end 130 may further comprise an inner support 134 disposed radially inward from the inner surface 132b of the male rib 132. In some embodiments, the inner support 134 may connect to and/or extend inwardly from the inner surface 132b of the male rib 132 The inner support 134 may provide reinforcement to the body (e.g., 115) of the filter core segment. In this regard, the inner support 134 may prevent the body from being extensible, for example, if pressure is applied diametrically, the inner support prevents the filter core segment from deforming, for example, to an elliptical footprint and rather enables the body to maintain the desired footprint. In some embodiments, the inner support may define an inner support diameter D₂, which is smaller than the outer diameter D₁ and the inner diameter D₃.

The inner support 134 may be attached to the inner surface 132b via a plurality of braces 136. In some embodiments, the plurality of braces 136 may be evenly spaced. In some embodiments, the number of the plurality of braces 136 may correspond to the number of columns 114. In one embodiment, the position of each brace may be aligned with a corresponding column, while in another embodiment the position of each of the braces may be off set from a corresponding column. Although, the inner support 134 and the plurality of braces 136 are illustrated as being on the male end 130, it should be understood that the neutral end 120 may additionally, or alternatively include an inner support 134 and a plurality of braces.

In some embodiments, in addition to providing support for the inner support 134, the plurality of braces 136 may prevent adjacent segments from rotating about the central axis (e.g., 101 FIG. 2) relative to one another. In this regard, two adjacent braces 136 are sized to be about the same size as the extension, such that there is a negligible gap on either side of the extension, between the extension and the adjacent braces when two segments are engaged.

Turning to the extensions, each extension 140 extends away from the male end in a height direction parallel to the central axis 101. In an embodiment, each extension 140 extends specifically from the inner surface 132b. Each extension 140 is attached to, or alternatively integral to the inner surface 132b of the male rib 132. Each extension 140 may also extend toward the central axis 101 in a width direction. The diameter measurement between diametrically opposed extensions 140 may be less than the inner diameter D₃. Each of the plurality of extensions 140 defines an extension height H₁ and an extension width W₁. The extension height H₁ may be measured from the male base wall 132c (see FIG. 2) to a tip 144d of the head 144.

Each extension 140 comprises a neck 142 extending from inner surface 132b of the male rib 132, and a head 144 extending from the neck 142 opposite the male rib 132. In some embodiments, the neck 142 may extend away from the male rib 132 parallel to the central axis 101, defining a neck height H₂. In some embodiments, the neck 142 may define an outer neck surface 142a and an opposite inner neck surface 142b defining a neck thickness T₁ therebetween. In some embodiments, the neck thickness T₁ may be constant, while in other embodiments the neck thickness T₁ may be variable.

In some embodiments, the head 144 defines a head outer surface 144a, a head inner surface 144b, and a bottom surface 144c. The head inner surface 144b may be an extension of the neck inner surface 142b. In some embodiments, the head outer surface 144a may be angled with respect to the head inner surface 144b. In this regard, the head outer surface 144a may extend at a 5 degree angle, a 10 degree angle, or a 15 degree angle from the head inner surface 144b. However, in other embodiments the head outer surface 144a may extend from the head inner surface 144b at an angle greater than 15 degrees, or even greater than 20 degrees. In this regard, the head 144 may define a varying thickness along a head height H₃ which extends between the bottom surface 144c and a tip 144d. The head thickness may be at a maximum at a transition point between the neck 141 and the bottom surface 144c of the head 144c. Thus, the bottom surface 144c may define a first head thickness T_{H1}, and the tip 144d may define a second head thickness T_{H2}, wherein the first head thickness T_{H1} is greater than the second head thickness T_{H2}.

In some embodiments, the bottom surface 144c of the head 144 may define the engagement surface between the extension 140 and the rib of the adjacent filter core segment (e.g., the neutral rib 122 or the male rib 132). In some embodiments, the bottom surface 144c may be curved, while in other embodiments the bottom surface 144c may be flat. In some embodiments, the bottom surface 144c may be smooth, while in other embodiments the bottom surface 144c may comprise one or more protrusions configured to engage with the rib of the adjacent filter core segment.

In some embodiments, the interface between the head outer surface 144a and the bottom surface 144c may be curved, while in other embodiments the head outer surface 144a and the bottom surface 144c may meet at a point.

In some embodiments, the neck thickness T₁ may be sized to provide resilience to the extension 140. In this regard, the neck 142 may be able to flex radially inward and return to the initial position. For example, the neck 142 may flex when connecting two adjacent filter core segments as the head 144 passes over the neutral rib 122 or the male rib 132 and may return to the initial position when the head 144 is positioned in the window 117 of the adjacent filter core segment. When the adjacent filter core segments are engaged the inner neck surface 142b may engage the inner surface 132b of rib of the adjacent filter core segment.

In some embodiments, the first head thickness T_{H1} is greater than the neck thickness T₁. In this regard, the difference in the first head thickness T_{H1} and the neck thickness T₁ provides the overlap between the head 144, i.e., the bottom surface 144c, and the rib of the adjacent filter core segment. In this regard, the first head thickness T_{H1} is sized to provide the requisite support to secure two adjacent filter core segments, while not extending beyond the outer surface 132a of the male rib 132, thereby providing a smooth outer surface of the resulting filter core. In some embodiments, the second head thickness T_{H2} may be the same size as the neck thickness T₁, while in other embodiments the second head thickness T_{H2} may be greater than the neck thickness T₁. In still other embodiments the second head thickness T_{H2} may be less than the neck thickness T₁.

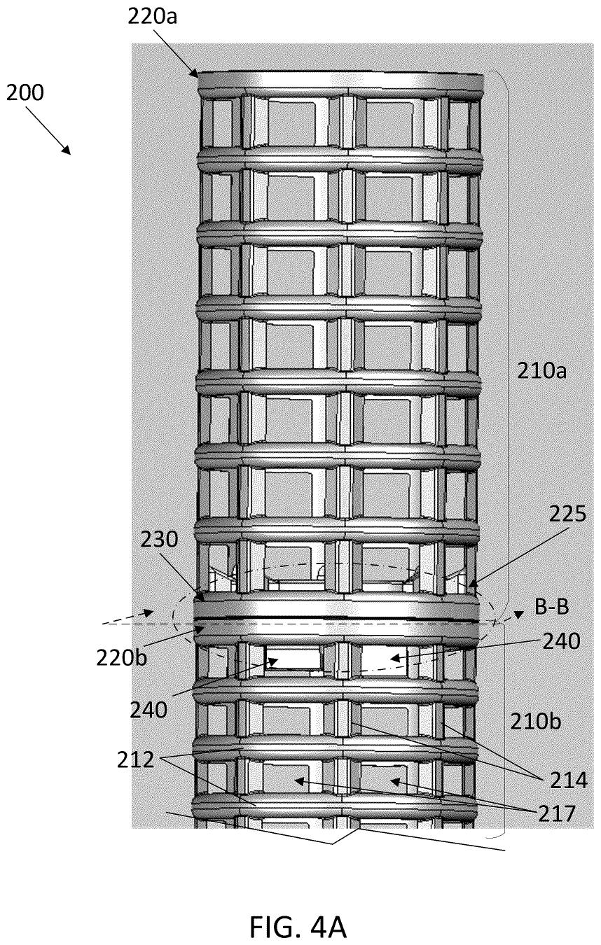

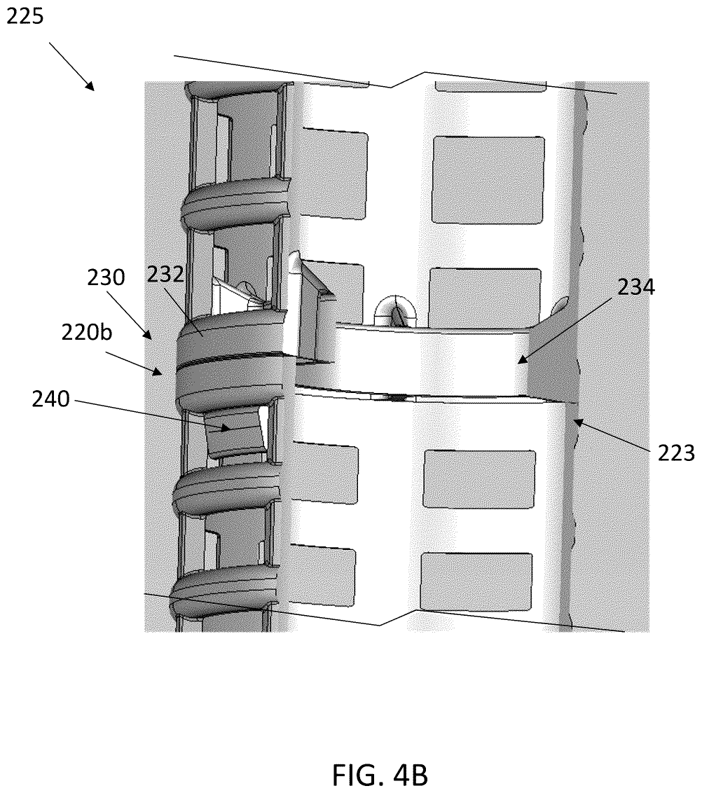

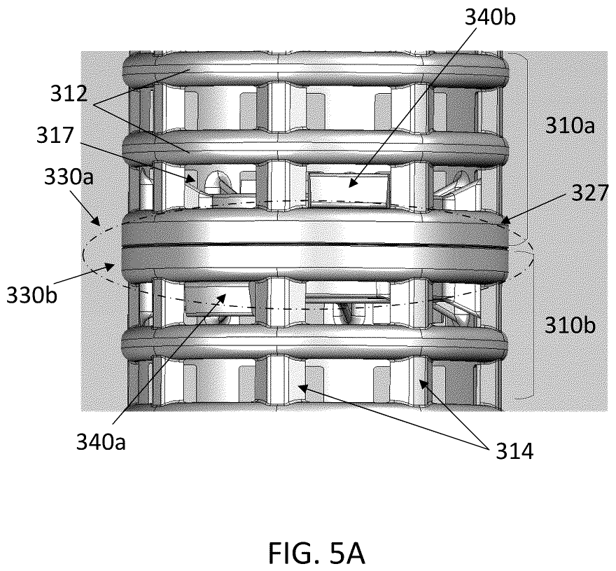

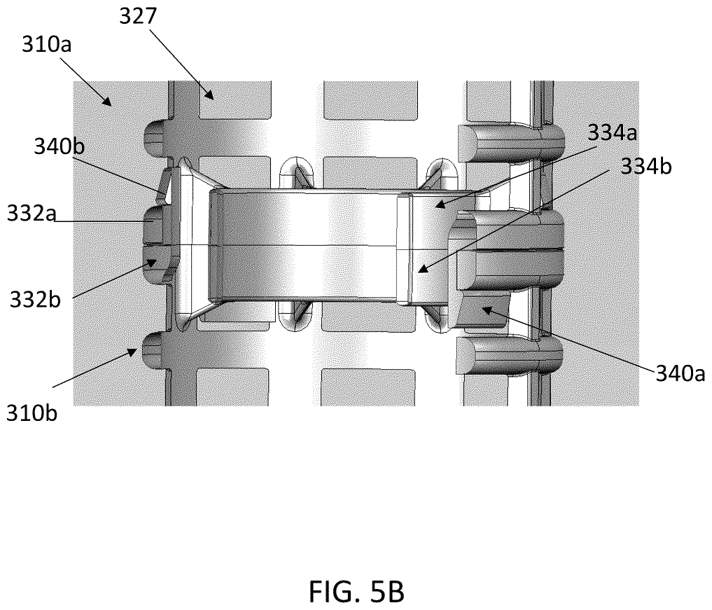

In order to engage properly with an adjacent filter core segment, as illustrated in FIGS. 1, 4A-C, and 5A-C, the plurality of extensions 140 are sized to be received by and engage with either the neutral end 120 (see FIGS. 4A-B) or male end 130 (see FIGS. 5A-B) of the adjacent filter core segment. In this respect, the plurality of extensions 140 may be sized to engage with both the neutral rib 121 and adjacent window 117, or the male rib 132 and adjacent window 131.

To facilitate the connection, the neck height H₃ may be the same size as a rib height H₄. In this regard, each of the neutral rib 122 and the male rib 132 may define the rib height H₄. Thus, the neck 142 of the extension 140, specifically the neck outer surface 142a may interface with the inner surface of the corresponding rib (e.g., the inner surface 132b of the mal rib 132) and the head 144 of the extension 140, specifically the bottom surface 144c may latch onto the respective rib, thereby securing the adjacent filter core segments. In this regard, the neutral rib 122 and the male rib 132, depending on the engagement surface, may act as a catch to support the extension 140, specifically the head 144 thereof.

Similarly, each window of the plurality of windows 117 may define a window height H₅. The window height H₅ may be sized to receive the head 144 of the extension 140. In this regard, the window height H₅ may be about the same size or larger than the head height H₃. In this regard, the head 144 of each extension 140 may fit within one of the plurality of windows 117 to secure adjacent filter core segments.

In some embodiments, the neck height H₂ and the head height H₃ may be equal, while in other embodiments the neck height H₂ and the head height H₃ may be different. In this regard, in some embodiments, the neck height H₂ may be greater than the head height H₃, while in other embodiments, the neck height H₂ may be less than the head height H₃.

To prevent the filter core segments from rotating in relation to one another about the center axis (see e.g., 101 FIG. 2) the extension width W₁ may be sized to fit within one of the plurality of windows 117. In this regard, each of the plurality of windows 117 bound by adjacent columns of the plurality of columns, and the windows 117 define a window width W₂ extending therebetween. In some embodiments, the window width W₂ may be larger than the extension width W₁. To explain, the extension width W₁ may be sized such that the head 144 is approximately flush with the adjacent columns. In this regard, the head width W₁ may be about the same size as the widow width W₂, or in other embodiments, the head width W₁ may be slightly smaller than the window width W₂.

As discussed, each filter core segment 110 may engage with a second filter core segment to create a filter core of the desired length. The resulting filter core, as illustrated in FIG. 1, illustrates each of the first end 102 and the second end 104 being smooth, i.e., there are no extensions extending from the ends. In this regard, each of the first end 102 and the second end 104 may be neutral ends of different filter core segments. Thus, as will be illustrated herein, the male end of a filter core segment may engage with either a neutral end 120, or a male end 130 of a second filter core segment.

FIGS. 4A-B illustrate a connection interface between a male end of a first filter core segment and a neutral end of a second filter core segment. To explain, a first filter core segment 210a defines a neutral end 220a and an opposite male end 230. The male end 230 of the first filter core segment 210a is attached to a second filter core segment 210 at a second neutral end 120b thereby defining a male-neutral interface 225.

Each of the filter core segments 210a, 210b comprise a plurality of columns 214 extending between the male end and the neutral end, and a plurality of ribs 212 disposed about the plurality of columns 214. The intersections between the plurality of ribs 212 and the plurality of columns 217 define a plurality of windows 217 which are opening within the filter core segments which allows a medium to pass through the filter core segments.

Each of the filter core segments comprise at least two diametrically opposed extensions 210 each extending from the male side 210 of the filter core segment. In the illustrated embodiment, the extensions 240 are shown extending from the first filter core segment 210a.

As discussed, the male end 230 may be defined by a male rib 232 and the neutral end 220b may be a neutral rib 222. In this regard, at the male-neutral interface 225 the male rib 232 of the first filter core segment 210a interfaces with the neutral rib 222 of the second filter core segment 210b. As illustrated in FIG. 4B, an inner support 234 is disposed radially inward from the male rib 232, as discussed the inner support 234 may provide additional structure, and rigidity to the filter core, thereby preventing deformation. In this regard, at the male-neutral interface 225 the neutral end 220b does not include an inner support, and thus, the structure is maintained by the male end 230.

Notably, in contrast to female/male interface of modular filters, or devices, which utilize a protruding feature on the male end, and a corresponding internal feature on the female end, where the protruding feature is received by the internal feature, the extension 240 is not received by a female (e.g., internal) feature formed integral to the neutral end 120. Rather, each of the extensions 240 engage with the neutral rib 222 and an associated window 217. The extensions 240, specifically the head (see e.g., 144 FIG. 3B) may be positioned such that the head will not be accidently, or easily disengaged from the window 217. Additionally, to separate the adjacent first filter core segment 210a and the second filter core segment 210b, both of the extensions must be pushed radially inward from the widow at the same time. Thus, the likelihood of an accidental dislodge is minimal.

In another embodiment, adjacent filter core segments may be joined in at a male-male interface.

To explain, a first filter core segment 310a defines a neutral end, not shown, and an opposite male end 330a. The male end 330a of the first filter core segment 310a is attached to a second filter core segment 310b at a second male end 330b thereby defining a male-male interface 327.

As discussed, each of the filter core segments 310a, 310b comprise a plurality of columns 214 extending between the male end and the neutral end, and a plurality of ribs 312 disposed about the plurality of columns 314. The intersections between the plurality of ribs 312 and the plurality of columns 317 define a plurality of windows 317 which are opening within the filter core segments which allows a medium to pass through the filter core segments.

The first filter core segment 310a comprises at least two extension 340a, and the second filter core segment 310b comprises at least two extensions 340b extending from the respective male side 330a, 330b. In the illustrated embodiment each of the extensions 340a, 340b are diametrically opposed.

As discussed, the male end 330 may be comprise a male rib 332. In this regard, at the male-male interface 327 the male rib 332a of the first filter core segment 310a interfaces with the male rib 332b of the second filter core segment 310b. As illustrated in FIG. 5B, an inner support 334a, 334b is disposed radially inward from an inner surface (see e.g., 132b FIG. 3B) of each of the first male end 330a, and the second male end 330b. As discussed, the inner support 334a, 334b may provide additional structure, and rigidity to the filter core, thereby preventing deformation. In this regard, at the male-male interface 327 the structure comprises two inner supports, thereby providing a greater support.

At the male-male interface 327 the extensions 340a extending from the first filter core segment 310a engage with the male rib 332b and an associated window 317 of the second filter core segment 310b. Similarly, the extensions 340b extending from the second filter core segment 310b engage with the male rib 332a and associated window 317 of the first filter core segment 310a.

Thus, the filter core segments may engage with either a male end or a neutral end of an adjacent filter core segment to create custom lengths of filter core. In this regard, as each of the filter core segments may engage with each of the neutral end or the male end of an adjacent filter core segment, the first end 102 and the second end 104 may each be free of protrusions.

Additionally, as the filter core segments may be formed in various sizes, the resulting filter core may formed in any discrete length necessary.

### Conclusion

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed:

1. A filter core segment comprising:
a male end comprising:
a male rib circumscribing a perimeter of the male end, wherein the male rib defines an outer surface and an inner surface;
an inner support disposed radially inward from the inner surface; and
a first extension and a second extension extending from the male rib and each comprising:
a neck extending from the inner surface of the male rib; and
a head extending from the neck, wherein the head protrudes radially outward from the inner surface of the male rib, towards a plane of the outer surface of the male rib;
a neutral end disposed opposite the male end;
a plurality of columns extending between the male end and the neutral end; and
a plurality of ribs extending about the plurality of columns,
wherein the first extension and the second extension are configured to engage either the male end or the neutral end of an adjacent filter core segment.

2. The filter core segment of claim 1, wherein the neutral end circumscribes a perimeter of a neutral rib, wherein the neutral rib is a uniform body which does not have any openings to receive the male end.

3. The filter core segment of claim 1, wherein the first extension and the second extension are diametrically opposed.

4. The filter core segment of claim 1, wherein the plurality of columns are evenly spaced about the perimeter of the male rib.

5. The filter core segment of claim 1, wherein the plurality of ribs are evenly spaced between the male end and the neutral end.

6. The filter core segment of claim 1, wherein the male end further comprises:
a plurality of braces extending between the external edge and the inner support.

7. The filter core segment of claim 6, wherein the plurality of columns are aligned with the plurality of braces.

8. The filter core segment of claim 1, wherein the male rib and a neutral rib each have the same height.

9. The filter core segment of claim 8, wherein a height of the neck of the first extension is the same as a height of the neck of the second extension, a height of the male rib, and a height of the neutral rib.

10. The filter core segment of claim 1, wherein the neck defines a neck thickness, wherein the neck thickness is consistent along the neck.

11. The filter core segment of claim 1, wherein the head defines a variable head thickness, wherein the head thickness is at a maximum at a transition between the neck and the head.

12. A filter core comprising:
a first filter core segment and a second filter core segment, the first filter core segment and the second filter core segment each comprising:
a male end comprising:
a male rib circumscribing a perimeter of the male end, wherein the male rib defines an outer surface and an inner surface;
an inner support disposed radially inward from the inner surface; and
a first extension and a second extension extending from the male rib and each comprising:
a neck extending from the inner surface of the male rib; and
a head extending from the neck, wherein the head protrudes radially outward from the inner surface of the male rib towards a plane of the outer surface of the male rib;
a neutral end disposed opposite the male end;
a plurality of columns extending between the male end and the neutral end; and
a plurality of ribs extending about the plurality of columns,
wherein the male end of the first filter core segment is engaged with one of either the male end or the neutral end of the second filter core segment.

13. The filter core segment of claim 12, wherein the neutral end circumscribes a perimeter of a neutral rib, wherein the neutral rib is a uniform body which does not have any openings to receive the male end.

14. The filter core of claim 12, wherein the first extension and the second extension are diametrically opposed.

15. The filter core of claim 12, wherein the plurality of columns are evenly spaced about the perimeter of the male rib.

16. The filter core of claim 12, wherein the plurality of ribs are evenly spaced between the male end and the neutral end.

17. The filter core of claim 12, wherein the male end further comprises:
a plurality of braces extending between the inner surface of the male rib and the inner support.

18. The filter core of claim 17, wherein the plurality of columns are aligned with the plurality of braces.

19. The filter core of claim 12, wherein a height of the neck of the first extension is the same as a height of the neck of the second extension, a height of the male rib, and a height of a neutral rib.

20. The filter core of claim 12, wherein the neck defines a neck thickness, wherein the neck thickness is consistent along the neck.

21. The filter core of claim 12, wherein the head defines a variable head thickness, wherein the head thickness is at a maximum at the transition between the neck and the head.

22. The filter core of claim 12, further comprising:
a third filter core segment comprising:
a male end comprising:
a male rib circumscribing a perimeter of the male end, wherein the male rib defines an outer surface and an inner surface;
an inner support disposed radially inward from the inner surface; and
a first extension and a second extension comprising:
a neck disposed on, extending upward from the inner surface of the male rib; and
a head extending from the neck, wherein the head protrudes radially outward from the inner surface of the male rib towards a plane of the outer surface of the male rib;
a neutral end disposed opposite the male end;
a plurality of columns extending between the male end and the neutral end; and
a plurality of ribs extending about the plurality of columns,
wherein the first and second extension of the third filter core segment are engaged with either the neutral end of the first filter core segment, the male end of the second filter core segment or the neutral end of the second filter core segment.

23. A filter core segment comprising:
a male end comprising:
a male rib circumscribing a perimeter of the male end, wherein the male rib comprises an outer surface and an opposite inner surface;
a plurality of braces extending radially inward from the inner surface of the male rib;
an inner support attached to the plurality of braces;
at least one extension extending away from the male rib, the at least one extension comprising:
a neck extending from the inner surface of the male rib; and
a head extending from the neck;
a neutral end comprising a neutral rib circumscribing a perimeter of the neutral end;
a plurality of columns extending between the male rib and the neutral rib;
a plurality of ribs concentrically spaced about the plurality of columns between the male rib and the neutral rib; and
a plurality of windows formed between the plurality of columns and the plurality of ribs, wherein a window adjacent the male rib or the neutral rib is configured to receive the head of at least one extension of an adjacent filter core segment.
